(19) United States
(12) Patent Application Publication
(10) Pub. No.: US 2014/0086557 A1
(43) Pub. Date: Mar. 27, 2014

(54) DISPLAY APPARATUS AND CONTROL METHOD THEREOF

(71) Applicant: Samsung Electronics Co., Ltd., Suwon-si (KR)

(72) Inventors: Guitao YU, Nanjing (CN); Bing JI, Nanjing (CN)

(73) Assignee: Samsung Electronics Co., Ltd., Suwon-si (KR)

(21) Appl. No.: 14/036,126

(22) Filed: Sep. 25, 2013

(30) Foreign Application Priority Data
Sep. 25, 2012 (CN) 201210360934.7
Jun. 25, 2013 (KR) 10-2013-0072950

(51) Int. Cl. H04N 9/87; G11B 27/031

(52) U.S. Cl. CPC H04N 9/87; G11B 27/031
USPC 386/241

(57) ABSTRACT

A display apparatus and a control method thereof which retrieves a frame of a recorded image corresponding to a frame of a processed image to set the retrieved frame as a key frame and displays the key frame corresponding to a position selected by the user includes an image reception unit, an image processing unit, a display unit, a storage unit, and a controller. The display apparatus may quickly and accurately determine a position of a scene from a recorded TV program, retrieve the scene, and edit the program.

### CROSS-REFERENCE TO RELATED APPLICATIONS

This application claims from the priority benefit of Chinese Patent Application No. 201210360934.7, filed on Sep. 25, 2012 in the State Intellectual Property Office of the People's Republic of China, and Korean Patent Application No. 10-2013-0072950, filed on Jun. 25, 2013 in the Korean Intellectual Property Office, the disclosures of which are incorporated herein by reference.

### BACKGROUND

1. Field

The following description relates to a display apparatus and a control method thereof, and more particularly, to a display apparatus capable of quickly and accurately determining and displaying a position of a scene in a recorded image in order to quickly and accurately retrieve a scene and to edit the image using a key frame, and a control method thereof.

2. Description of the Related Art

A recorded image may be selectively played back and edited for user convenience if needed. A digital display technique provides functions of retrieving a video stream scene and editing a video stream with respect to a recorded video. These functions may be applied to both playing the recorded image and playing a time shift of a TV program. To provide such functions, a position of a particular scene or video frame may need to be detected.

To retrieve a scene, a conventional method decodes a key frame obtained by acquiring a position of the key frame on a transport stream according to a predetermined time interval and determines a position of the scene from the decoded key frame. That is, because a position of a key frame for retrieving a scene is unique and fixed according to a time interval, determining a position of the scene is not accurately performed, resulting in superficial retrieval of a scene without achieving practical retrieval.

In a conventional method, when a user edits a recorded image, for example, when the user cuts the recorded image or removes part of the recorded image, an editing point is required to be selected in playing the recorded image, that is, in determining a position of a scene, and the editing is conducted at the selected spot. However, the user selected position may be a connected key frame, not a needed key frame. That is, when the recorded image is edited, it is not easy for the user to select an editing position, and the user may not accurately determine the position of the scene, making it impossible to precisely edit the recorded image.

Therefore, to quickly and accurately retrieve a scene and edit a program, a method and an apparatus for rapidly and precisely determining a position of a scene from a recorded image are needed.

### SUMMARY

Additional aspects and/or advantages will be set forth in part in the description which follows and, in part, will be apparent from the description, or may be learned by practice of the invention.

The following description relates to a display apparatus which is capable of retrieving a frame of a recorded image corresponding to a frame of a processed image to set a key frame and displaying the key frame corresponding to a position selected by a user, and a control method thereof.

The foregoing and/or other aspects may be achieved by providing a display apparatus including an image reception unit to receive an image, an image processing unit to process the received image, a display unit to display the processed image, a storage unit to store a recorded image, and a controller to retrieve a frame of the recorded image corresponding to a frame of the processed image, to set the retrieved frame as a key frame of the recorded image, and to control the image processing unit to process and display the key frame corresponding to a position of a frame when the position of the frame to display is selected by a user.

The controller may retrieve a frame having the same presentation time stamp (PTS) as the frame of the processed image based on a system time stamp (STS) of the frame of the recorded image.

The controller may derive a frame characteristic of the set key frame and sets a scene transition key frame of the recorded image based on the derived frame characteristic.

The frame characteristic may include a similarity level and uniformity level between adjacent key frames.

The similarity level may be a ratio of similar regions between the adjacent key frames derived using at least one of histograms, moments, and structures of an entire region of the key frame.

The uniformity level may be a matching ratio of identical regions between the adjacent key frames derived using at least one of scale invariant feature transform (SIFT) and speeded-up robust feature (SURF) of part of a region of the key frame.

When the derived ratio of similar regions is a predetermined level or higher, the controller may determine that there is no scene transition key frame.

When the derived ratio of similar regions is less than the predetermined level, the controller may derive the matching ratio of identical regions.

When the derived matching ratio of identical regions is less than a predetermined level, the controller may set a later key frame of the adjacent key frames as the scene transition key frame.

When the derived matching ratio of identical regions is the predetermined level or higher, the controller may determine that there is no scene transition key frame.

The foregoing and/or other aspects may be achieved by providing a control method of a display apparatus, the control method including receiving an image, processing the received image, recording and storing the received image, retrieving a frame of the recorded image corresponding to a frame of the processed image, setting the retrieved frame as a key frame of the recorded image, and processing and displaying the key frame corresponding to a position of a frame when the position of the frame to display is selected by a user.

The retrieving the frame of the recorded image may include retrieving a frame having the same presentation time stamp (PTS) as the frame of the processed image based on a system time stamp (STS) of the frame of the recorded image.

The setting as the key frame may further include deriving a frame characteristic of the set key frame and setting a scene transition key frame of the recorded image based on the derived frame characteristic.

The frame characteristic may include a similarity level and uniformity level between adjacent key frames.

The similarity level may be a ratio of similar regions between the adjacent key frames derived using at least one of histograms, moments, and structures of an entire region of the key frame.

The uniformity level may be a matching ratio of identical regions between the adjacent key frames derived using at least one of scale invariant feature transform (SIFT) and speeded-up robust feature (SURF) of part of a region of the key frame.

The setting the scene transition key frame may include determining that there is no scene transition key frame when the derived ratio of similar regions is a predetermined level or higher.

The setting the scene transition key frame may include deriving the matching ratio of identical regions when the derived ratio of similar regions is less than the predetermined level.

The deriving the matching ratio of identical regions may include setting a later key frame of the adjacent key frames as the scene transition key frame when the derived matching ratio of identical regions is less than a predetermined level.

The deriving the matching ratio of identical regions may include determining that there is no scene transition key frame when the derived matching ratio of identical regions is the predetermined level or higher.

As described above, a display apparatus and a control method thereof according to exemplary embodiments may be capable of retrieving a frame of a recorded image corresponding to a frame of a processed image to set a key frame and displaying the key frame corresponding to a position selected by a user, thereby quickly and accurately determining a position of a scene from a recorded TV program, and thus, rapidly and precisely retrieving the scene and editing the program.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram illustrating a configuration of a display apparatus according to an exemplary embodiment.

FIG. 2 schematically illustrates scene change detection by the display apparatus according to an exemplary embodiment.

FIGS. 3A and 3B schematically illustrate playback of key frames on the display apparatus according to an exemplary embodiment.

FIGS. 4A to 4C illustrate a process of playing and editing a recorded image by the display apparatus according to an exemplary embodiment.

FIG. 5 is a flowchart illustrating a method of determining a position of a scene of a recorded video by the display apparatus according to an exemplary embodiment.

FIG. 6 schematically illustrates a process of retrieving and storing a key frame by the display apparatus according to an exemplary embodiment.

FIG. 7 is a block diagram illustrating a configuration of a display apparatus for determining a position of a scene of a recorded video according to an exemplary embodiment.

FIGS. 8A and 8B illustrate a process of selecting a target scene frame on a playback progress bar according to an exemplary embodiment.

FIG. 9 is a flowchart illustrating a method of determining a position of a scene of a recorded video according to an exemplary embodiment.

FIG. 10 is a flowchart illustrating a method of determining a position of a scene of a recorded video according to an exemplary embodiment.

FIG. 11 is a block diagram illustrating a configuration of a display apparatus according to an exemplary embodiment.

FIG. 12 is a flowchart illustrating an operation of the display apparatus according to an exemplary embodiment.

### DETAILED DESCRIPTION

Below, exemplary embodiments will be described in detail with reference to accompanying drawings to be easily realized by a person having ordinary knowledge in the art. The exemplary embodiments may be embodied in various forms without being limited to the exemplary embodiments set forth herein. Descriptions of well-known parts are omitted for clarity and conciseness, and like reference numerals refer to like elements throughout.

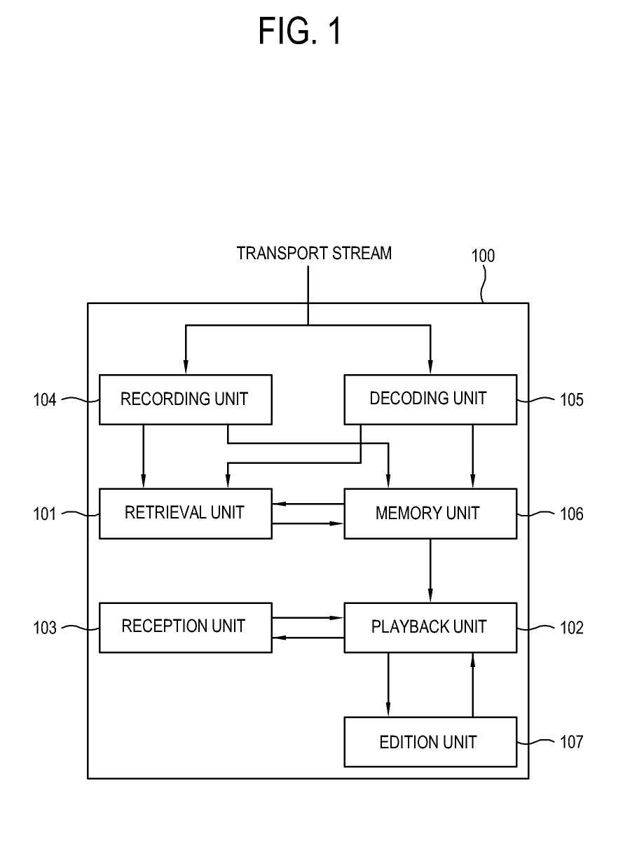

FIG. 1 is a block diagram illustrating an apparatus 100 for determining a position of a scene of a recorded video according to an exemplary embodiment.

Referring to FIG. 1, the apparatus 100 for determining the position of the scene of the recorded video according to the present embodiment may include a retrieval unit 101, a playback unit 102, and a reception unit 103.

In the present embodiment, the apparatus 100 may further include a recording unit 104, a decoding unit 105, and a memory unit 106. When the apparatus 100 receives a transport stream, the apparatus 100 separates the transport stream into two channels of signals, and transmits one of the signals to the recording unit 104 and the other signal to the decoding unit 105. The recording unit 104 records the received transport stream, and the decoding unit 105 decodes the received transport stream. The recording unit 104 stores the recorded transport stream in the memory unit 106 for filing and editing, and the decoding unit 105 transmits the decoded transport stream to a display unit (not shown). Recording and decoding the received transport stream may be performed simultaneously by the recoding unit 104 and the decoding unit 105, although the present embodiment is not limited to recording and decoding simultaneously. The recording unit 104 and the decoding unit 105 may be connected to the retrieval unit 101, and accordingly, the retrieval unit 101 may access the recording unit 104 and the decoding unit 105.

The retrieval unit 101 may retrieve a key frame from the recorded transport stream and store the retrieved key frame based on system timestamps. The key frame may be an intra-coded (I) frame.

In detail, when the recording unit 104 records the transmitted transport stream, the retrieval unit 101 may generate an index of the key frame of the transmitted transport stream, wherein the index may include a presentation timestamp (PTS) and a system timestamp (STS) of the key frame. For example, the retrieval unit 101 may store the generated index of the key frame of the recorded transport stream in the memory unit 106. When the decoding unit 105 decodes the received transport stream, the retrieval unit 101 captures the decoded key frame to store the PTS and STS of the decoded key frame, which may be stored, for example, in the memory unit 106. The retrieval unit 101 retrieves, from the recorded transport stream, a key frame including the same PTS as the decoded key frame within a predetermined range of the STS of each decoded key frame based on the index.

For example, the predetermined range may be an STS of the decoded key frame +5S, that is, a range from STS −5S to STS +5S, without being limited thereto. Because an error may occur in a PTS value of a transport stream in a process of transmitting or generating transport streams, the retrieval unit 101 matches a PTS value based on an STS value. When the retrieval unit 101 retrieves, from the recorded transport stream, the key frame having the same PTS as that of a particular key frame decoded within the predetermined range, the retrieved key frame is stored. For example, the retrieval unit 101 may store the retrieved key frame in a JPEG format within a proper range in the memory unit 106 through sub sampling. When the retrieval unit 101 does not retrieve the key frame having the same PTS as that of the particular key frame decoded within the predetermined range, the decoded key frame is omitted.

According to the present embodiment, when the retrieved key frame is stored, the retrieval unit 101 may retrieve and store a scene transition key frame of the stored key frame.

In detail, the retrieval unit 101 may derive similarity between adjacent key frames among stored key frames based on generic characteristics of the key frames. The generic characteristics of the key frames may include histograms, moments, and structures of the key frames, without being limited thereto. When the derived similarity is a first predetermined level or higher, the retrieval unit 101 may determine that no scene change occurs between the adjacent frames. When the derived similarity is less than the first predetermined level, the retrieval unit 101 may match fragmentary features of key frames extracted from the adjacent key frames. The fragmentary features of the key frames may further include scale invariant feature transform (SIFT) or speeded-up robust features (SURF).

When a matching value of the fragmentary features of the key frames is a second predetermined level or higher, the retrieval unit 101 may determine that no scene change occurs between the adjacent frames. When the matching value is less than the second predetermined level, the retrieval unit 101 determines that a scene change occurs between the adjacent frames and stores a later frame among the adjacent frames as the scene transition frame and as a key frame for selecting a target scene frame. The retrieval unit 101 may store the scene transition frame in the memory unit 106. The first predetermined value and the second predetermined value may be a default value or be set by a user.

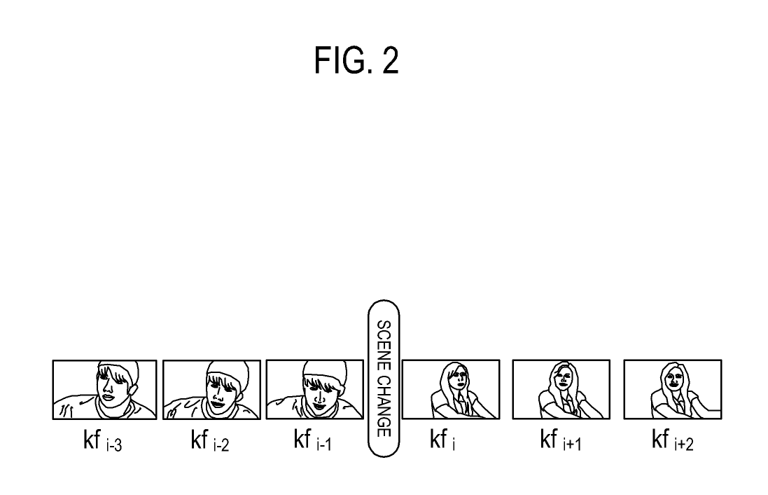

FIG. 2 schematically illustrates scene change detection according to an exemplary embodiment. FIG. 2 shows six consecutive frames kfi−3, kfi−2, kfi−1, kfi, kfi+1 and kfi+2. Here, kfi−3, kfi−2, and kfi−1 correspond to the same scene, while kfi, kfi+1, and kfi+2 correspond to another scene. As seen in FIG. 2, a scene change occurs between kfi−3 and kfi, and kfi may need to be stored. The retrieval unit 101 may record all received key frames as KF={kf0,kf1, . . . , kfi−1,kfi,kfi+1, . . . , kf N−1,kfN} before retrieving a scene transition key frame, and detect a scene change with respect to each of the key frames based on generic and fragmentary characteristics of the key frames. When the retrieval unit 101 determines that a scene change occurs between adjacent key frames, the retrieval unit 101 stores a later frame among the adjacent key frames as the scene transition key frame and as a key frame for selecting a target scene frame. For example, the retrieval unit 101 may store kfi among kfi−1 and kfi between which the scene change occurs as the scene transition key frame and as the key frame for selecting the target scene frame.

Referring to FIG. 1, the playback unit 102 may play back the key frame stored in the memory unit 106. The key frame may be the retrieved key frame or the scene transition key frame additionally retrieved from retrieved key frames.

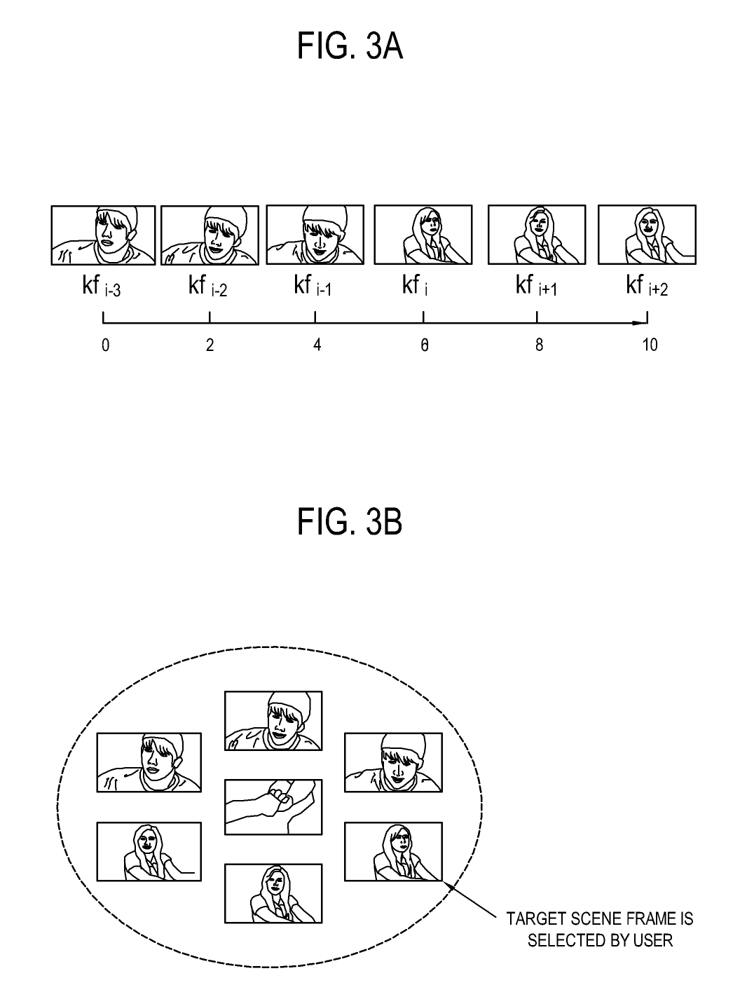

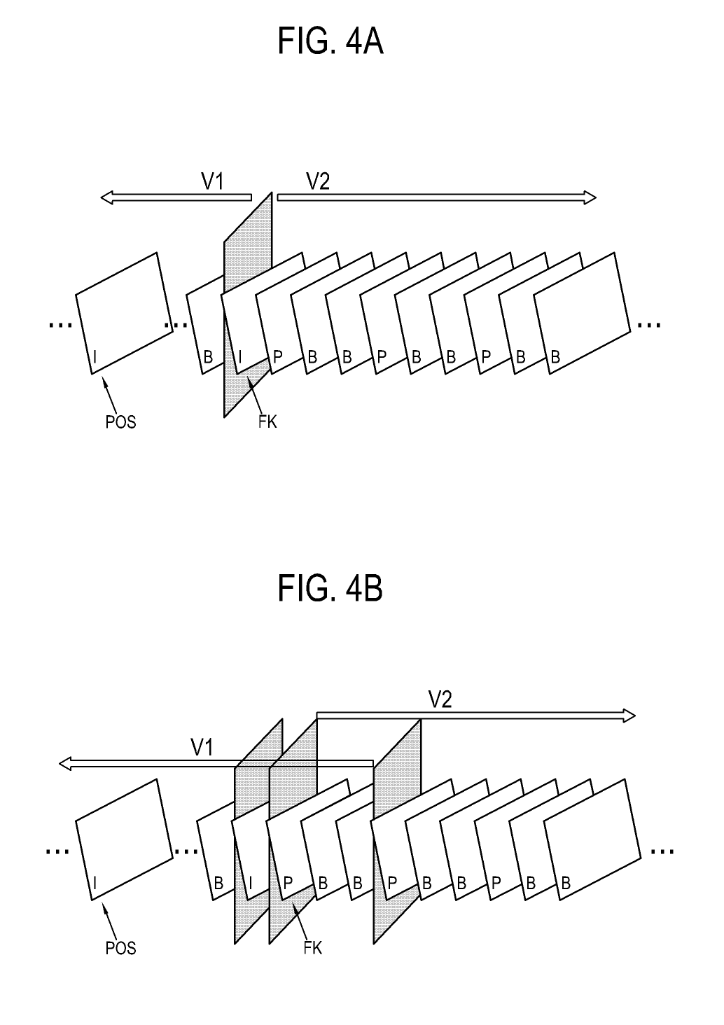

In detail, when a user needs to determine the position of the scene of the recorded transport stream, the playback unit 102 may play back the key frame on the display unit (not shown). The playback unit 102 may play back the key frame slowly or display a plurality of key frames of the key frames simultaneously on the display unit, without being limited thereto. FIGS. 3A and 3B illustrate playback of key frames according to an exemplary embodiment. Referring to FIG. 3A, the playback unit 102 plays backs the key frames at low speed, for example, ½ frame per second. Referring to FIG. 3B, the playback unit 102 displays a plurality of key frames, for example, seven key frames, simultaneously on the display unit.

The reception unit 103 may receive a target scene frame selected by the user among key frames played by the playback unit 102. Specifically, the user may select a key frame played at low speed or a target scene frame to be involved in position determination or edition among the key frames simultaneously displayed on the display unit by the playback unit 102.

The index of the key frame of the recorded transport stream may further include a start packet position of the key frame of the recorded transport stream and a length of the key frame. When the reception unit 103 receives the target scene frame selected by the user, the playback unit 102 acquires a position corresponding the target scene frame of the recorded transport stream based on the index and starts playing the recorded transport stream at the acquired position. For example, the playback unit 102 may play back the recorded transport stream at low speed.

The apparatus 100 may further include the edition unit 107. While the playback unit 102 plays back the recorded transport stream at the acquired position, the edition unit 107 may receive a target position determined by the user for editing the recoded transport stream and edit the recorded transport stream based on the target position. Editing may include cutting and removing.

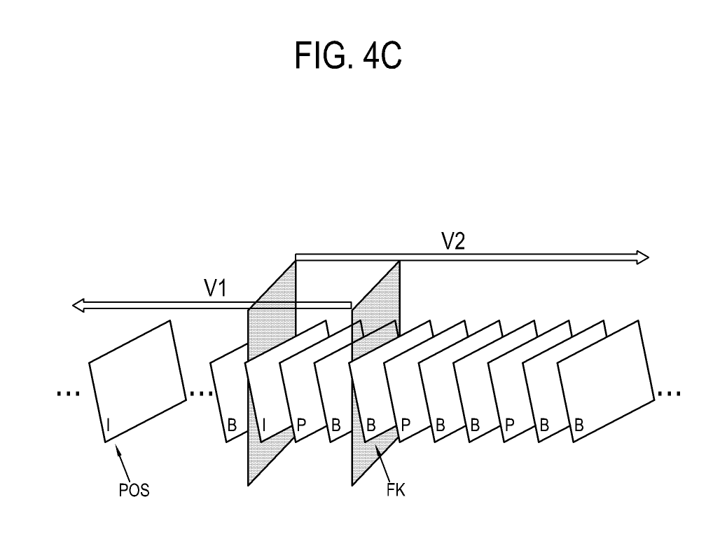

Specifically, FIGS. 4A to 4C illustrate a process of editing the recorded transport stream based on the target position determined by the user. When the target position FK determined by the user for editing the recorded transport stream is an I frame, that is, a key frame, the edition unit 107 determines that the target position is an end point of a first edited part V1 of the recorded transport stream and the target position is a starting point of a second edited part V2 of the recorded transport stream, as shown in FIG. 4A.

When the target position FK determined by the user for editing the recorded transport stream is a P frame, the edition unit 107 determines that a B frame having a largest decoding time stamp (DTS) among a plurality of B frames after the target position is an end point of a first edited part V1 of the recorded transport stream and an I frame right before the target position is a starting point of a second edited part V2 of the recorded transport stream, as shown in FIG. 4B.

When the target position FK determined by the user for editing the recorded transport stream is a B frame, the edition unit 107 determines that the target position is an end point of a first edited part V1 of the recorded transport stream and an I frame right before the target position is a starting point of a second edited part V2 of the recorded transport stream, as shown in FIG. 4C.

The foregoing editing method may not allow omission of some of edited scenes, enables quick subdivision of the recorded transport stream, and provides accurate edited effects to the user.

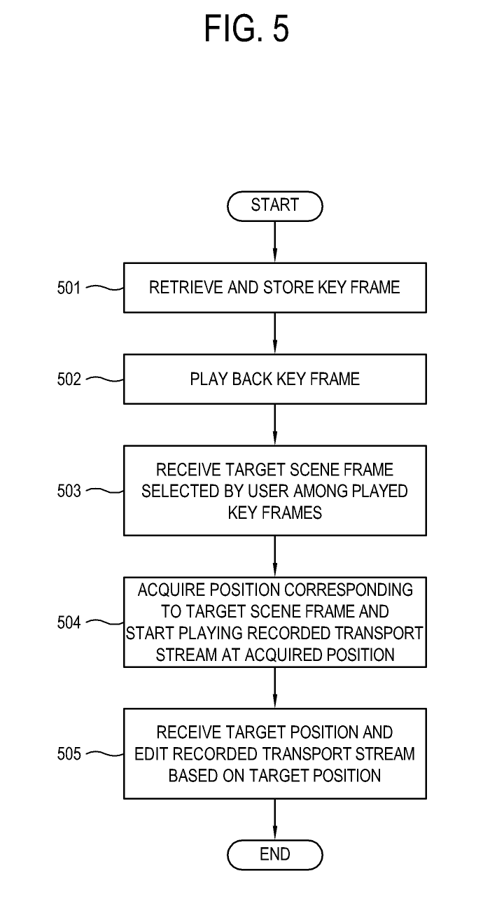

FIG. 5 is a flowchart illustrating a method of determining a position of a scene of a recorded video according to an exemplary embodiment.

Referring to FIG. 5, the retrieval unit 101 may retrieve and store a key frame from a recorded transport stream based on an STS in operation 501.

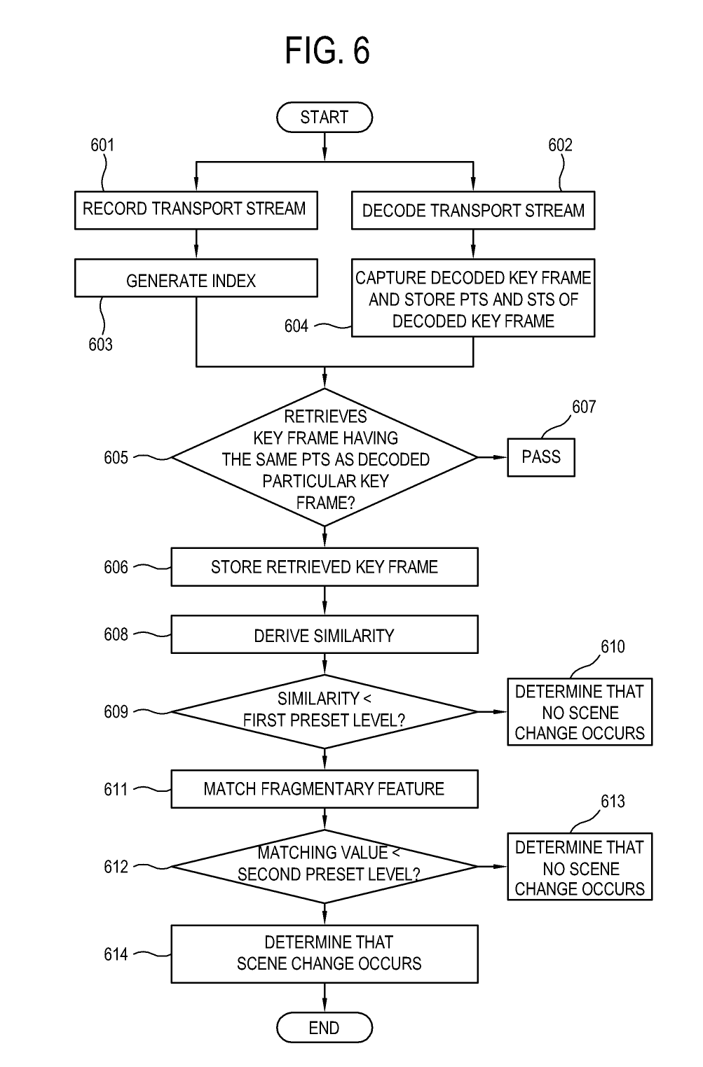

FIG. 6 schematically illustrates a process of retrieving and storing the key frame according to an exemplary embodiment.

Referring to FIG. 6, the recording unit 104 records the received transport stream in operation 601. The decoding unit 105 decodes the received transport stream in operation 602. Although operations 601 and 602 may be carried out simultaneously, the present embodiment is not limited thereto. When the recoding unit 104 records the received transport stream in operation 601, the retrieval unit 101 generates an index of the key frame of the recorded transport stream in operation 603, wherein the index may include a PTS and STS of the key frame. When the decoding unit 105 decodes the received transport stream in operation 602, the retrieval unit 101 captures the decoded key frame to store the PTS and STS of the decoded key frame in operation 604.

The retrieval unit 101 retrieves, from the recorded transport stream, a key frame having the same PTS as each decoded key frame within a predetermined range of the STS of the decoded key frame based on the index in operation 605. When the retrieval unit 101 retrieves, from the recorded transport stream, the key frame having the same PTS as that of a particular key frame decoded within the predetermined range, the retrieval unit 101 stores the retrieved key frame in operation 606. When the retrieval unit 101 does not retrieve, from the recorded transport stream, the key frame having the same PTS as that of the particular key frame decoded within the predetermined range, the retrieval unit 101 skips the decoded key frame in operation 607.

The process of retrieving and storing the key frame according to the present embodiment may further include retrieving and storing a scene transition key frame in operations 608 to 614. Referring to FIG. 6, in operation 608, the retrieval unit 101 may derive similarity between adjacent key frames among stored key frames based on generic characteristics of the key frames. The generic characteristics of the key frames may include histograms, moments, and structures of the key frames, without being limited thereto. When the derived similarity is a first predetermined level or higher in operation 609, the retrieval unit 101 may determine that no scene change occurs between the adjacent frames in operation 610. When the derived similarity is less than the first predetermined level in operation 609, the retrieval unit 101 may match fragmentary features of key frames extracted from the adjacent key frames in operation 611. The fragmentary features may further include SIFT or SURF of the key frames.

When a matching value of the fragmentary features of the key frames is a second predetermined level or higher in operation 612, the retrieval unit 101 may determine that no scene change occurs between the adjacent frames in operation 613. When the matching value is less than the second predetermined level in operation 612, the retrieval unit 101 determines that a scene change occurs between the adjacent frames in operation 614 and stores a later frame among the adjacent frames as the scene transition frame and as a key frame for selecting a target scene frame.

Referring to FIG. 5, the playback unit 102 may play back the key frame in operation 502. The key frame may be the retrieved key frame or the scene transition frame additionally retrieved from retrieved key frames.

In detail, when the user needs to determine the position of the scene of the recorded transport stream, the playback unit 102 may play back the key frame on the display unit (not shown). The playback unit 102 may play back the key frame slowly or display a plurality of key frames of the key frames simultaneously on the display unit, without being limited thereto.

In operation 503, the reception unit 103 may receive a target scene frame selected by the user among the played key frames. Specifically, the user may select a key frame played at low speed or a target scene frame to be involved in position determination or edition among the key frames simultaneously displayed on the display unit by the playback unit 102.

The index of the key frame of the recorded transport stream may further include a start packet position of the key frame of the recorded transport stream and a length of the key frame. When the reception unit 103 receives the target scene frame selected by the user in operation 503, the playback unit 102 acquires a position corresponding to the target scene frame of the recorded transport stream based on the index and starts playing the recorded transport stream at the acquired position in operation 504. For example, the playback unit 102 may play back the recorded transport stream at low speed.

In operation 505, the edition unit 107 may receive a target position determined by the user for editing the recoded transport stream and edit the recorded transport stream based on the target position while the playback unit 102 plays back the recorded transport stream at the acquired position. Editing may include cutting and removing.

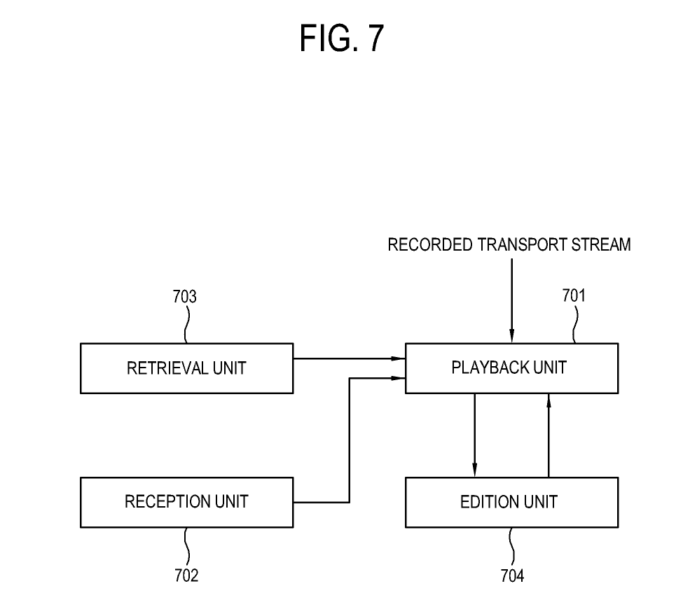

FIG. 7 is a block diagram illustrating an apparatus 100 for determining a position of a scene of a recorded video according to an exemplary embodiment.

Referring to FIG. 7, the apparatus 700 for determining the position of the scene of the recorded video according to the present embodiment may include a playback unit 701, a reception unit 702, and a retrieval unit 703.

The playback unit 701 may play back a recorded transport stream on a display unit (not shown).

The reception unit 702 may receive a time and a moving direction with respect to a position on a playback progress bar of the playback unit 701 specified by the user. The moving direction may include a forward direction when the received time is after a current time and a backward direction when the received time is before the current time.

The retrieval unit 703 may retrieve a key frame closest to the time received by the reception unit 702 on the playback progress bar of the playback unit 701. In detail, when the moving direction is the forward direction, the retrieval unit 703 retrieves, using a binary retrieval method, a key frame having an STS closest to the received time between the current time and an end point of the recorded transport stream. When the moving direction is the backward direction, the retrieval unit 703 retrieves, using the binary retrieval method, a key frame having an STS closest to the received time between a starting point of the recorded transport stream and the current time.

Here, the playback unit 701 may further play back the key frame closest to the received time and a plurality of key frames close to the key frame. For example, the playback unit 701 may play back the key frame closest to the received time and the plurality of key frames close to the key frame at low speed or simultaneously display the key frame closest to the received time and the plurality of key frames close to the key frame, without being limited thereto. Before playing back the key frame closest to the received time and the plurality of key frames close to the key frame, the playback unit 701 may pause the recorded transport stream for a moment, without being limited thereto.

The reception unit 702 may further receive a target scene frame selected by the user among the key frames played by the playback unit 701.

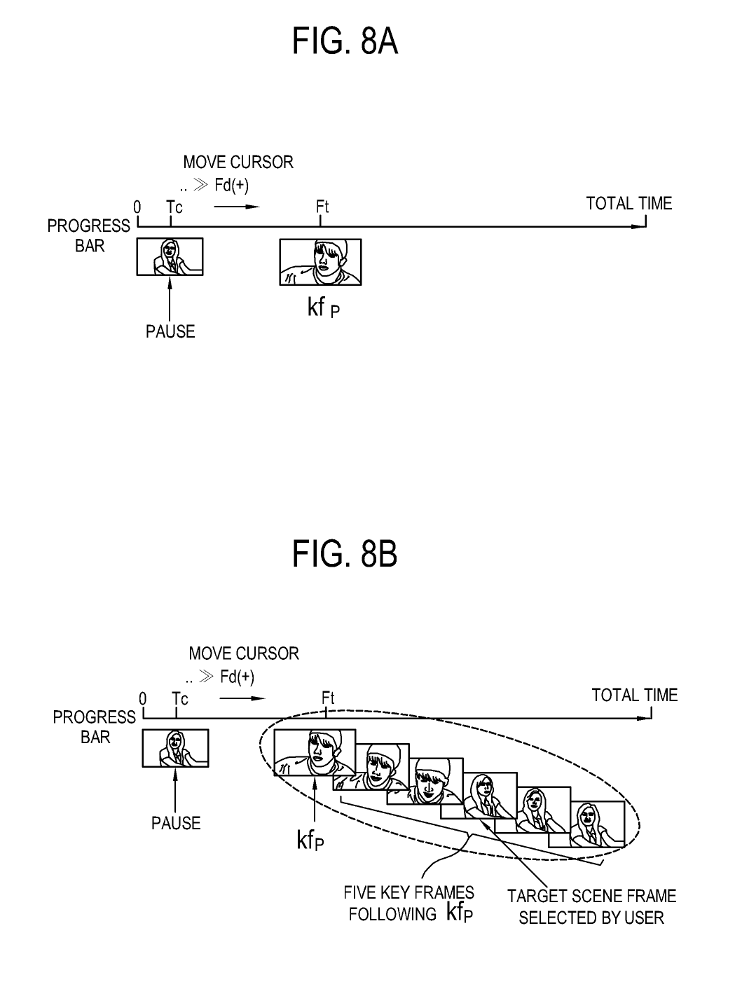

For example, FIGS. 8A and 8B illustrate a process of selecting a target scene frame on the playback progress bar according to an exemplary embodiment. As shown in FIG. 8A, when the playback unit 701 of the apparatus 700 plays back the recorded transport stream at the current time Tc, the user may pause the transport stream and move a cursor on the playback progress bar. When the user selects the position by moving the cursor to a particular position, the reception unit 702 may receive the time Ft and the moving direction Fd(+) with respect to the position on the playback progress bar selected by the user. The forward direction may be defined as Fd(+) and the backward direction may be defined as Fd(-), without being limited thereto. The retrieval unit 703 retrieves the key frame kfp closest to Ft. As shown in FIG. 8B, the playback unit 701 plays back the key frame kfp closest to Ft and five key frames following the key frame kfp. Here, the reception unit 702 may receive a target scene frame selected by the user among the six played key frames.

Referring to FIG. 7, before the playback unit 701 plays back the recorded transport stream, the retrieval unit 703 may generate an index of a key frame of the recorded transport stream when the received transport stream is recorded. The index includes a start packet position of the key frame of the recorded transport stream, a length of the key frame, and an STS of the key frame.

When the reception unit 702 receives the target scene frame selected by the user among the key frames played by the playback unit 701, the play back unit 701 acquires a position corresponding to the target scene frame of the recorded transport stream based on the index and starts playing the recorded transport stream at the acquired position. Here, the playback unit 701 may play back the recorded transport stream at low speed using slow stunt.

The apparatus 700 may further include an edition unit 704. The edition unit 704 performs the same function as the edition unit 107 of the apparatus 100 for determining the position of the scene of the recorded video, and thus description of the edition unit 704 is omitted herein.

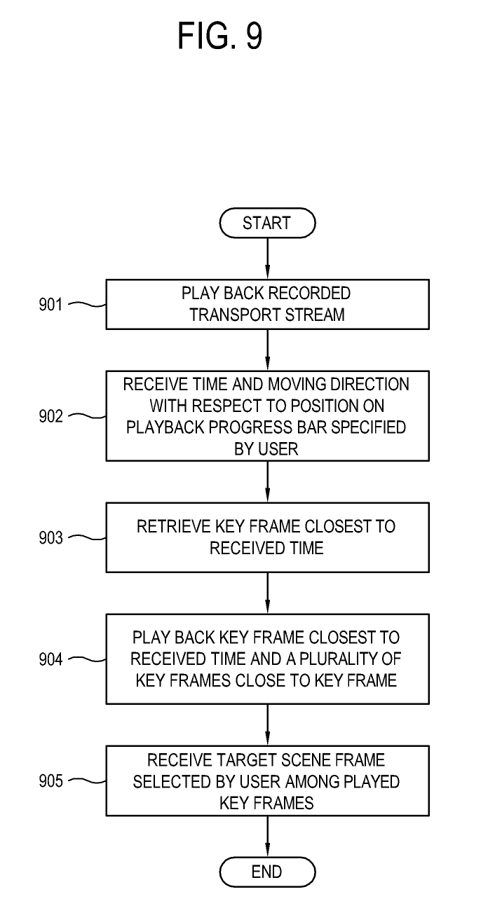

FIG. 9 is a flowchart illustrating a method of determining a position of a scene of a recorded video according to an exemplary embodiment.

Referring to FIG. 9, the playback unit 701 may play back a recorded transport stream on the display unit (not shown) in operation 901.

In operation 902, the reception unit 702 may receive a time and a moving direction with respect to a position on a playback progress bar specified by the user. The moving direction may include a forward direction when the received time is after a current time and a backward direction when the received time is before the current time.

In operation 903, the retrieval unit 703 may retrieve a key frame closest to the received time. In detail, when the moving direction is the forward direction, the retrieval unit 703 retrieves, using a binary retrieval method, a key frame having an STS closest to the received time between the current time and an end point of the recorded transport stream. When the moving direction is the backward direction, the retrieval unit 703 retrieves, using the binary retrieval method, a key frame having an STS closest to the received time between a starting point of the recorded transport stream and the current time.

In operation 904, the playback unit 701 may further play back the key frame closest to the received time and a plurality of key frames close to the key frame. For example, the playback unit 701 may play back the key frame closest to the received time and the plurality of key frames close to the key frame at low speed or simultaneously display the key frame closest to the received time and the plurality of key frames close to the key frame, without being limited thereto. Before playing back the key frame closest to the received time and the plurality of key frames close to the key frame, the playback unit 701 may pause the recorded transport stream for a moment, without being limited thereto.

In operation 905, the reception unit 702 may receive a target scene frame selected by the user among the played key frames.

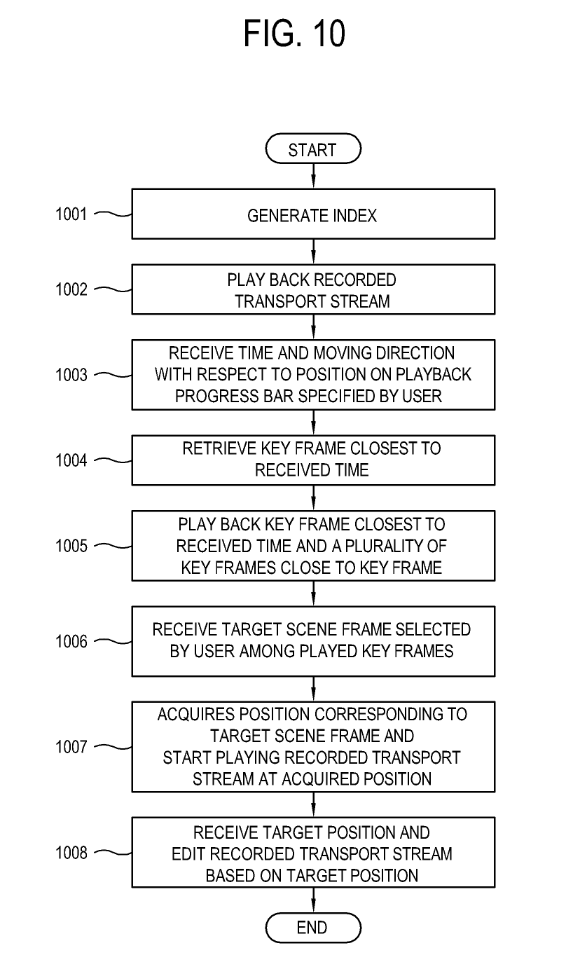

FIG. 10 is a flowchart illustrating a method of determining a position of a scene of a recorded video according to an exemplary embodiment.

Referring to FIG. 10, in operation 1001, the retrieval unit 703 may generate an index of a key frame of a recorded transport stream when the received transport stream is recorded. The index includes a start packet position of the key frame of the recorded transport stream, a length of the key frame and an STS of the key frame.

Operations 1002, 1003, 1004, 1005, and 1006 of FIG. 10 correspond to operations 901 to 905 of FIG. 9, respectively, and thus descriptions thereof are omitted herein.

In operation 1007, the playback unit 701 acquires a position corresponding to a target scene frame of the recorded transport stream based on the index and starts playing the recorded transport stream at the acquired position. Here, the playback unit 701 may play back the recorded transport stream at low speed.

In operation 1008, while the playback unit 702 plays back the recorded transport stream at the acquired position, the edition unit 704 may receive a target position determined by the user for editing the recoded transport stream and edit the recorded transport stream based on the target position. Editing may include cutting and removing, for example.

The method and apparatus for determining the position of the scene of the recorded video according to the foregoing embodiments enable quick and accurate scene retrieval and position determination, so that the user may accurately edit the recorded video.

In a display apparatus 1 according to an exemplary embodiment, the terms used in the foregoing embodiments may be described as follows.

The transport stream may refer to a video and an image from an external source. The recording unit, which records an image, may be a part of a controller 100. The playback unit may be an image processing unit 120 to process an image to display on a display unit 130. The retrieval unit to retrieve an image frame may be a part of the controller 100. The memory unit may be a storage unit 140 to store a recorded image and different types of data. The reception unit may be an image reception unit 110 to receive an image. The edition unit to correct an image may be a part of the controller 100. The decoding unit may be the image processing unit 120 to process images.

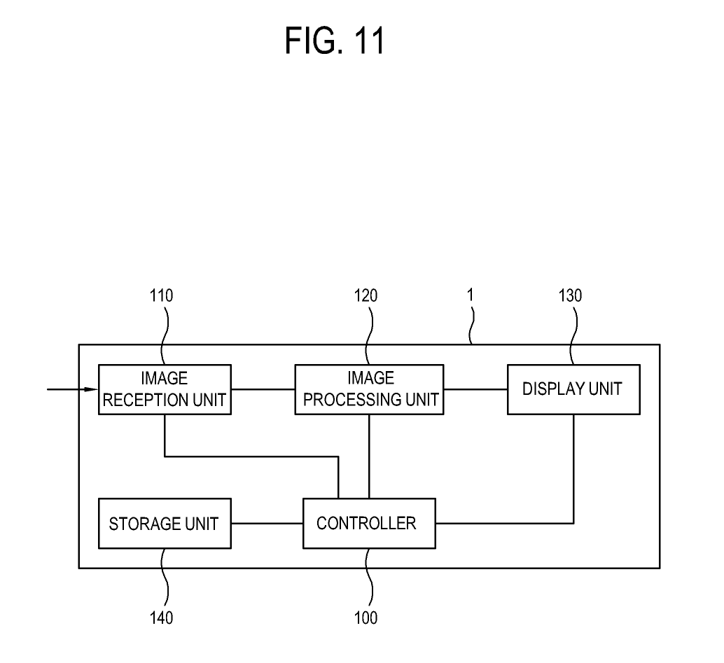

FIG. 11 is a block diagram illustrating a configuration of the display apparatus 1 according to an exemplary embodiment. As shown in FIG. 11, the display apparatus 1 according to the present embodiment may include the image reception unit (image receiver) 110, the image processing unit (image processor) 120, the display unit (display) 130, the storage unit (storage) 140, and the controller 100.

The image reception unit 110 receives an image signal/image data via a cable or wirelessly and transmits the image signal/image data to the image processing unit 120. The image reception unit 110 may be configured as various types corresponding to standards of received image signals and configurations of the display apparatus 1. For example, the image reception unit 110 may receive a radio frequency (RF) signal or various image signals in accordance with composite video, component video, super video, SCART, high definition multimedia interface (HDMI), DisplayPort, unified display interface (UDI), or wireless HD standards. When an image signal is a broadcast signal, the image reception unit 110 includes a tuner to tune the broadcast signal by each channel.

The image reception unit 110 receives an image signal. The reception unit 110 may receive a broadcast signal from a broadcast signal transmission unit (not shown), for example, a TV broadcast signal, as an image signal, receive an image signal from an imaging device, such as a DVD player and a BD player, receive an image signal from a PC, receive an image signal from mobile equipment, such as a smartphone and a smart pad, receive an image signal through a network, such as the Internet, or receive an image content stored in a storage medium, such as a USB storage medium, as an image signal. Alternatively, the image signal may be stored in the storage unit 140, instead of provided through the image reception unit 110.

The image processing unit 120 may perform any kind of image processing, for example, without being limited to, decoding corresponding to an image format of image data, de-interlacing to convert interlaced image data into a progressive form, scaling to adjust image data to a predetermined resolution, noise reduction to improve image quality, detail enhancement, frame refresh rate conversion, or the like.

The image processing unit 120 may be provided as an integrated multi-functional component, such as a system on chip (SOC), or as an image processing board (not shown) formed by mounting separate components which independently conduct individual processes on a printed circuit board, and be embedded in the display apparatus 1.

The image processing unit 120 may perform various predetermined image processing processes on a broadcast signal including an image signal received from the image reception unit 110 and a source image including an image signal provided from an image source (not shown). The image processing unit 120 outputs the processed image signal to the display apparatus 1, so that the processed source image may be displayed on the display apparatus 1.

The display unit 130 displays an image based on an image signal output from the image processing unit 120. The display unit 130 may be configured in various display modes using liquid crystals, plasma, light emitting diodes, organic light emitting diodes, a surface conduction electron emitter, a carbon nano-tube, nano-crystals, or the like, without being limited thereto.

The display unit 130 may further include an additional component depending on a display mode thereof. For example, when in a display mode using liquid crystals, the display unit 130 includes a liquid crystal display (LCD) panel (not shown), a backlight unit (not shown) to provide light to the panel, and a panel driving board (not shown) to drive the panel.

The display unit 130 may display an image based on an image signal processed by the image processing unit 120. The display unit 130 may display an image in any method, for example, without being limited to, using LCD, a plasma display panel (PDP) and an organic light emitting (OLED). In this case, the display unit 130 may include an LCD panel, a PDP, and an OLED panel.

The storage unit 140 may be configured as a writable nonvolatile memory, for example, a writable read only memory (ROM), to retain stored data even when not powered and to reflect changes by a user. That is, the storage unit 140 may be configured as any one of a flash memory, electrically erasable and programmable read only memory and erasable and programmable read only memory. The storage unit 140 may record and store a received image.

The controller 100 may retrieve a frame of a recorded image corresponding to a frame of a processed image and set the retrieved frame as a key frame of the recorded image. When the user selects a position of the frame to display, the controller 100 may control the image processing unit 120 to process and display the key frame corresponding to the selected position.

The controller 100 may retrieve a frame having the same PTS as the frame of the processed image based on an STS of the frame of the recorded image. Because an error may occur in a PTS value of an image in transmitting or generating some images, the controller 100 of the present embodiment may match a PTS value based on an STS.

The controller 100 may derive frame characteristics of the set key frame and set a scene transition key frame of the recorded image based on the derived frame characteristics. The frame characteristics may a similarity level and a uniformity level between adjacent key frames. The similarity level may be a ratio of similar regions between adjacent key frames derived using at least one of histograms, moments, and structures of an entire regions of key frames. The uniformity level may be a matching ratio of identical regions between adjacent key frames derived using at least one of SIFT and SURF of some regions of key frames.

When the derived ratio of similar regions is a predetermined level or higher, the controller 100 may determine that there is no scene transition key frame.

When the derived ratio of similar regions is less than the predetermined level, the controller 100 derives the matching ratio of identical regions. Then, when the derived matching ratio of identical regions is less than a predetermined level, the controller 100 may set a later frame of the adjacent frames as a scene transition key frame. Here, when the derived matching ratio of identical regions is the predetermined level or higher, the controller 100 may determine that there is no scene transition key frame.

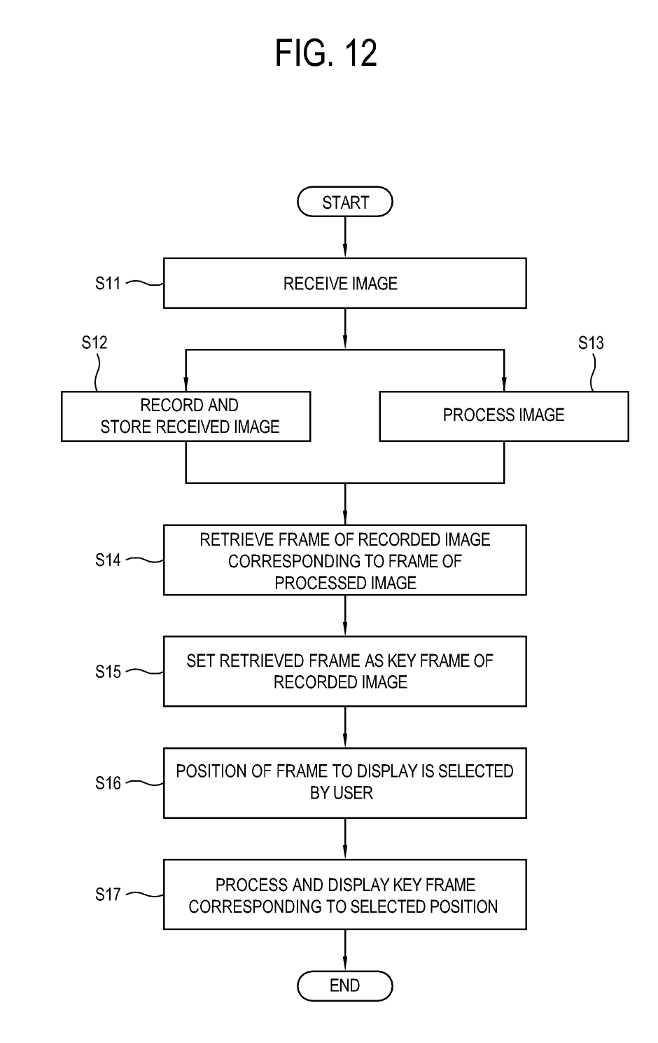

FIG. 12 is a flowchart illustrating an operation of the display apparatus 1 according to an exemplary embodiment. The operation of the display apparatus 1 will be described with reference to FIG. 12.

The display apparatus 1 receives an image (operation S11). The display apparatus 1 records and stores the received image (operation S12). The display apparatus 1 may generate an index of a key frame (I frame) of the received image, wherein the generated index includes an STS and a PTS. The display apparatus 1 decodes the received image (operation S13). The display apparatus 1 may capture the decoded key frame and store the PTS and STS of the decoded key frame. The display apparatus 1 retrieves a frame of the recorded image corresponding to the frame of the processed image (operation S14). The display apparatus 1 may retrieve a frame having the same PTS as the frame of the processed image based on the STS of the frame of the recorded image.

The display apparatus may set the retrieved frame as a key frame of the recorded image (operation S15). The set key frame may be stored in the storage unit 140. Here, when the key frame is set, the display apparatus 1 may derive a similarity level and a uniformity level between adjacent key frames with respect to the key frame. The similarity level may be a ratio of similar regions between adjacent key frames derived using at least one of histograms, moments and structures of entire regions of key frames. The uniformity level may be a matching ratio of identical regions between adjacent key frames derived using at least one of SIFT and SURF of some regions of key frames. A scene transition key frame of the recorded image may be set based on the derived characteristics of the key frame.

Here, when the derived ratio of similar regions is a predetermined level or higher, the display apparatus 1 may determine that there is no scene transition key frame. When the derived ratio of similar regions is less than a predetermined level, the display apparatus 1 derives the matching ratio of identical regions. Then, when the derived matching ratio of identical regions is less than a predetermined level, the display apparatus 1 may set a later frame of the adjacent frames as a scene transition key frame. When the derived matching ratio of identical regions is the predetermined level or higher, the display apparatus 1 may determine that there is no scene transition key frame. A position of the frame to display is selected by the user (operation S16). The display apparatus 1 processes and displays the key frame corresponding to the selected position on the display unit 130 (operation S17).

The display apparatus 1 retrieves a frame of a recorded image corresponding to a frame of a processed image to set the retrieved frame as a key frame and displays the key frame corresponding to a position selected by the user, thereby quickly and accurately determining a position of a scene from a recorded TV program, retrieving the scene, and editing the program.

The above-described embodiments may be recorded in computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
an image reception unit to receive an image;
an image processing unit to process the received image;
a display unit to display the processed image;
a storage unit to store a recorded image; and
a controller to retrieve a frame of the recorded image corresponding to a frame of the processed image, to set the retrieved frame as a key frame of the recorded image, and to control the image processing unit to process and display the key frame corresponding to a position of a frame when the position of the frame to display is selected by a user.

2. The display apparatus of claim 1, wherein the controller retrieves a frame having a same presentation time stamp (PTS) as the frame of the processed image based on a system time stamp (STS) of the frame of the recorded image.

3. The display apparatus of claim 1, wherein the controller derives a frame characteristic of the set key frame and sets a scene transition key frame of the recorded image based on the derived frame characteristic.

4. The display apparatus of claim 3, wherein the frame characteristic comprises a similarity level and uniformity level between adjacent key frames.

5. The display apparatus of claim 4, wherein the similarity level comprises a ratio of similar regions between the adjacent key frames derived using at least one of a histogram, moment, and structure of a region of the key frame.

6. The display apparatus of claim 4, wherein the uniformity level comprises a matching ratio of identical regions between the adjacent key frames derived using at least one of scale invariant feature transform (SIFT) and speeded-up robust feature (SURF) of part of a region of the key frame.

7. The display apparatus of claim 5, wherein when the derived ratio of similar regions is greater than or equal to a first predetermined level, the controller determines that there is no scene transition key frame.

8. The display apparatus of claim 6, wherein when the derived ratio of similar regions is less than a first predetermined level, the controller derives the matching ratio of identical regions.

9. The display apparatus of claim 8, wherein when the derived matching ratio of identical regions is less than a second predetermined level, the controller sets a later key frame of the adjacent key frames as the scene transition key frame.

10. The display apparatus of claim 8, wherein when the derived matching ratio of identical regions is greater than or equal to a second predetermined level, the controller determines that there is no scene transition key frame.

11. A control method of a display apparatus, the control method comprising:
receiving an image;
processing the received image;
recording and storing the received image;
retrieving a frame of the recorded image corresponding to a frame of the processed image;
setting the retrieved frame as a key frame of the recorded image; and
processing and displaying the key frame corresponding to a position of a frame when the position of the frame to display is selected by a user.

12. The control method of claim 11, wherein the retrieving the frame of the recorded image comprises retrieving a frame having a same presentation time stamp (PTS) as the frame of the processed image based on a system time stamp (STS) of the frame of the recorded image.

13. The control method of claim 11, wherein the setting as the key frame further comprises deriving a frame characteristic of the set key frame and setting a scene transition key frame of the recorded image based on the derived frame characteristic.

14. The control method of claim 13, wherein the frame characteristic comprises a similarity level and uniformity level between adjacent key frames.

15. The control method of claim 14, wherein the similarity level is a ratio of similar regions between the adjacent key frames derived using at least one of a histogram, moment, and structure of a region of the key frame.

16. The control method of claim 14, wherein the uniformity level is a matching ratio of identical regions between the adjacent key frames derived using at least one of scale invariant feature transform (SIFT) and speeded-up robust feature (SURF) of part of a region of the key frame.

17. The control method of claim 15, wherein the setting the scene transition key frame comprises determining that there is no scene transition key frame when the derived ratio of similar regions is greater than or equal to a first predetermined level.

18. The control method of claim 15, wherein the setting the scene transition key frame comprises deriving the matching ratio of identical regions when the derived ratio of similar regions is less than a first predetermined level.

19. The control method of claim 18, wherein the deriving the matching ratio of identical regions comprises setting a later key frame of the adjacent key frames as the scene transition key frame when the derived matching ratio of identical regions is less than a second predetermined level.

20. The control method of claim 18, wherein the deriving the matching ratio of identical regions comprises determining that there is no scene transition key frame when the derived matching ratio of identical regions is greater than or equal to a second predetermined level.
